(19) United States
(12) Patent Application Publication
(10) Pub. No.: US 2012/0306633 A1
(43) Pub. Date: Dec. 6, 2012

(54) SENSORY OUTPUT SYSTEM, APPARATUS AND METHOD

(75) Inventors: Courtney Heron, Naperville, IL (US); David Gradl, Naperville, IL (US); Robert Campbell, Naperville, IL (US)

(73) Assignee: TOUCHSENSOR TECHNOLOGIES, LLC, Wheaton, IL (US)

(21) Appl. No.: 13/469,483

(22) Filed: May 11, 2012

Related U.S. Application Data
(63) Continuation-in-part of application No. 13/332,597, filed on Dec. 21, 2011.
(60) Provisional application No. 61/426,144, filed on Dec. 22, 2010.

(51) Int. Cl. G08B 6/00

(52) U.S. Cl. 340/407.2

(57) ABSTRACT

A sensory output system includes a data input section, a user input section, a processing section and a sensory output section. The processing section receives information representative of a geometric form or other measurable parameter from the data input section, and it receives information representative of user input from the user input section. The processing section compares the information received from the data input section with the information received from the user input section according to predetermined criteria. The processing section provides the sensory output section with a signal indicative of whether the predetermined criteria are satisfied. When the predetermined criteria are satisfied, the sensory output section provides a sensory output.

### CROSS-REFERENCE TO RELATED APPLICATIONS

This application claims benefit as a continuation-in-part of U.S. patent application Ser. No. 13/332,597, filed on Dec. 21, 2011, which claims priority to U.S. Provisional Patent Application No. 61/426,144, filed on Dec. 22, 2010. The disclosures of the foregoing applications are incorporated herein by reference in their entireties.

### SUMMARY OF THE DISCLOSURE

The present invention is directed to apparatus, systems and methods for processing plural streams of information and/or information from plural sources and selectively generating a sensory output when the information received from one of such streams or sources corresponds to the information received from at least another of such streams or sources according to predetermined criteria. In an illustrative embodiment, a sensory output system receives a first stream of information or information from a first source, a second stream of information or information from a second source, compares the information from the two streams and/or sources, and selectively provides a sensory output when the information from the first and second streams and/or sources corresponds according to predetermined criteria. The sensory output can be haptic output or another form of sensory output, for example, visible or audible output.

### BRIEF DESCRIPTION OF THE DRAWINGS

FIG. 1 is a block diagram of an illustrative sensory output system 10 including a data input section 20, a user input section 30, a sensory output section 50 and a processing section 40 adapted to receive signals from data input section 20 and user input section 30, to compare such signals, and to selectively provide an output signal to sensory output section 50 according to predetermined criteria;

FIG. 1A is a block diagram of an illustrative sensory output section 50 adapted to provide a haptic output signal;

FIG. 2 is a perspective view of an illustrative sensory output device 70 for use in connection with, and embodying at least certain elements of, sensory output system 10;

FIG. 2A is a block diagram of a portion of sensory output device 70 including user input section 30 and sensory output section 50;

FIG. 3 is a representation of an illustrative locus of points 60 in the form of a letter “T”;

FIG. 4 is a representation of another illustrative locus of points 60′ in the form of a clock face and hands;

FIG. 5 is a plan view of a sensory output device 70 including a user input pad 74 and showing thereon in dashed lines a representation of locus of points 60;

FIG. 6 is a representation of a locus of points defining the shape of the letter “T” in the context of a Cartesian coordinate system;

FIG. 7 is a plan view of the electrode layers of a touch pad;

FIG. 8 is an exploded side cross-sectional view of the layers of the touch pad illustrated in FIG. 7;

FIG. 9 is an elevation view of a vessel V including multiple data input section sensors 22A-22F associated with the sidewall thereof and an associated user input module 34;

FIG. 10 is an elevation view of vessel V including a float-type level sensor 24 and an associated user input module 34;

FIG. 11 is a perspective view of a data input module 24 emulating a slide switch and an associated user input module 34; and

FIG. 12 is a plan view of a data input module 24 in the form of a weathervane and an associated user input module 34.

### DETAILED DESCRIPTION OF CERTAIN EMBODIMENTS

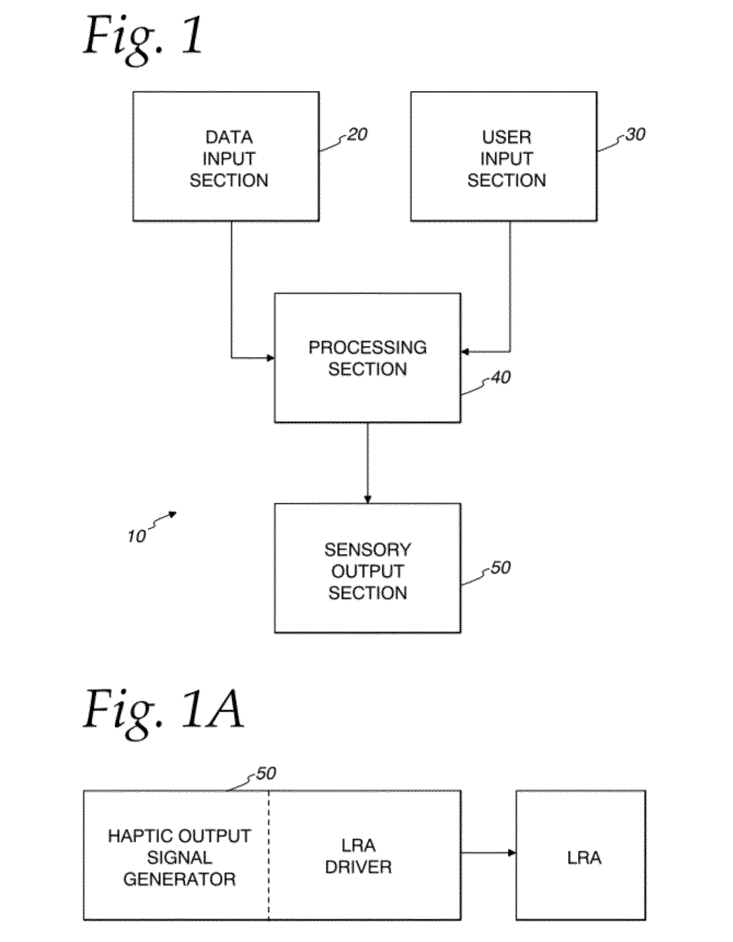

FIG. 1 is a block diagram showing certain components of an illustrative sensory output system 10, including a data input section 20, a user input section, a sensory output section 50 and a processing section 40 that receives inputs from data input section 20 and user input section 30 and selectively provides an output to sensory output section 40 as a function of whether the inputs from data input section 20 correspond to the inputs from user input section 30 according to predetermined criteria (sometimes referred to herein as “correspondence criteria”).

Data input section 20 could be embodied as any form of device, software and/or circuitry capable of providing to processing section 40 an output signal or signals representative of relevant information. Specific examples of such devices, software and/or circuitry include, without limitation, analog and/or digital switches and/or sensors, data storage devices, data receivers, data generators and associated software and circuitry, as would be understood by one skilled in the art. The relevant information could take virtually any form and could be stored or generated in data input section 20 or obtained from any number of sources external to data input section 20, either wirelessly or through a wired connection. Specific examples of relevant information include, without limitation, information representative of a geometric form or shape and information representative of a measurable quantity, for example, information representative of a scalar or other value.

User input section 30 could be embodied as any form of device, software and/or circuitry capable of sensing user input and providing an output signal or signals representative of the user input. Specific examples of such devices, software and/or circuitry (sometimes referred to herein as “sensing elements”) include, without limitation, touch pads, touch screens, analog and/or digital switches and/or sensors, and related software and circuitry, as would be understood by one skilled in the art. Touch pads are commonly used as pointing devices for laptop computers and portable music players and may be used in other devices and in other ways. Touch screens commonly are used in smart phones and portable music players and may be used in other devices and in other ways. (The term “touch input panel” may be used herein to refer to a touch pad and/or a touch screen.) Analog and digital switches and sensors commonly are used to detect fluid level, position, temperature, voltage, speed, and orientation, among other parameters.

Processing section 40 could be embodied as any form of device, software and/or circuitry capable of receiving output signals from data input section 20 and user input section 30 through wired or wireless means, comparing the signals from those two sources according to predetermined criteria, and providing to sensory output section 50 through wired or wireless means a signal indicative of whether the predetermined criteria have been satisfied. The signal indicative of whether the predetermined criteria have been satisfied could be a first form of output signal when the signals from the two sources are deemed to correspond to each other according to predetermined criteria and a second form of output signal when the signals from the two sources are deemed to not correspond to each other according to the predetermined criteria, as discussed further below. Specific examples of such devices, software and/or circuitry hardware include, without limitation, microprocessors, data storage devices and related software and circuitry, as would be understood by one skilled in the art. Either of the foregoing output signals could be a high level output, a low level output, an intermediate level output or a null output (that is, no output), as would be understood by one skilled in the art. The foregoing predetermined criteria could be stored in processing section 40 or elsewhere.

Output section 50 could be embodied as any form of circuitry, software and/or hardware capable of selectively providing a sensory output in response to signals received from processing section 40. The sensory output could be haptic, visual, audible and/or any other form of sensory output. Specific examples of structure for providing visual output include, without limitation, displays, LEDs and other light sources, and related circuitry, software and/or hardware, as would be understood by one skilled in the art. Specific examples of structure for providing audible output include, without limitation, speakers, buzzers, bells, chimes and related circuitry, software and/or hardware, as would be understood by one skilled in the art. Specific examples of structure for providing haptic output include, without limitation, linear resonant actuators (LRAs), LRA drivers, haptic output signal generators and related circuitry, software and/or hardware, as would be understood by one skilled in the art.

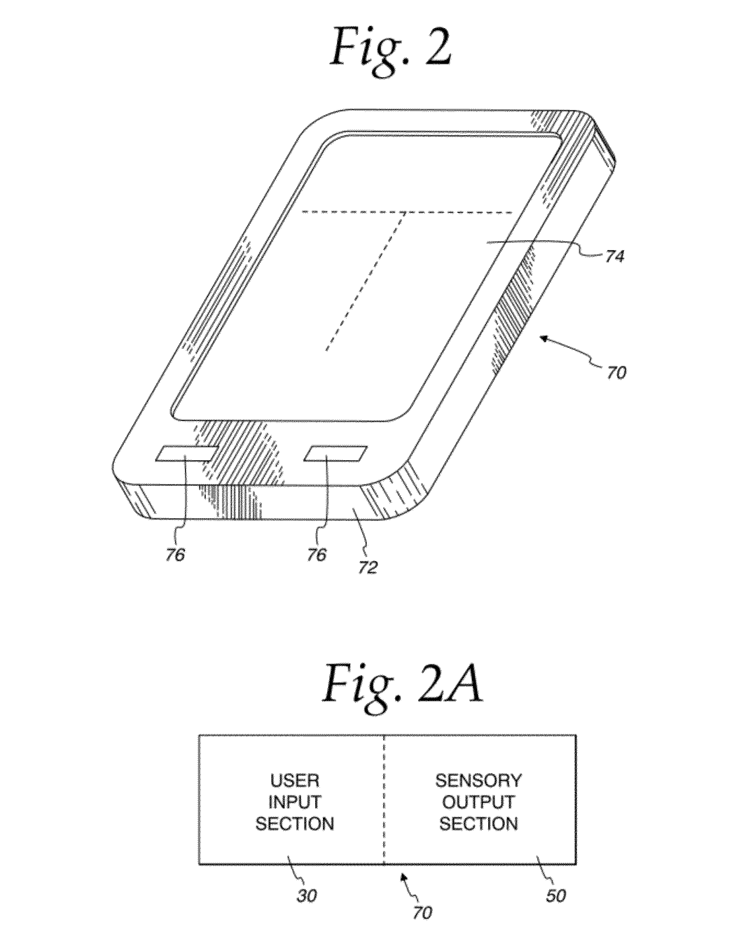

The foregoing sections and components of sensory output system 10 could be contained in a single device, housing, panel or other container. For example, with reference to FIGS. 2 and 5, and as discussed further below, the foregoing sections and components of sensory output system 10 could be embodied in a sensory output device 70 including a housing 72, a touch pad or touch screen 74, and other structure and circuitry for implementing sensory output system 10. In an illustrative embodiment, sensory output device 70 could be a smart phone or other device incorporating means for receiving, storing, and/or generating data, a processor, a touch pad or touch screen for receiving user input, and means for providing haptic or other sensory output. Such devices may also include auxiliary switches or sensors 76 for receiving user input. Alternatively, the foregoing sections and components of sensory output system 10 could be distributed among more than one device, housing, panel and/or other container, as will be discussed further below.

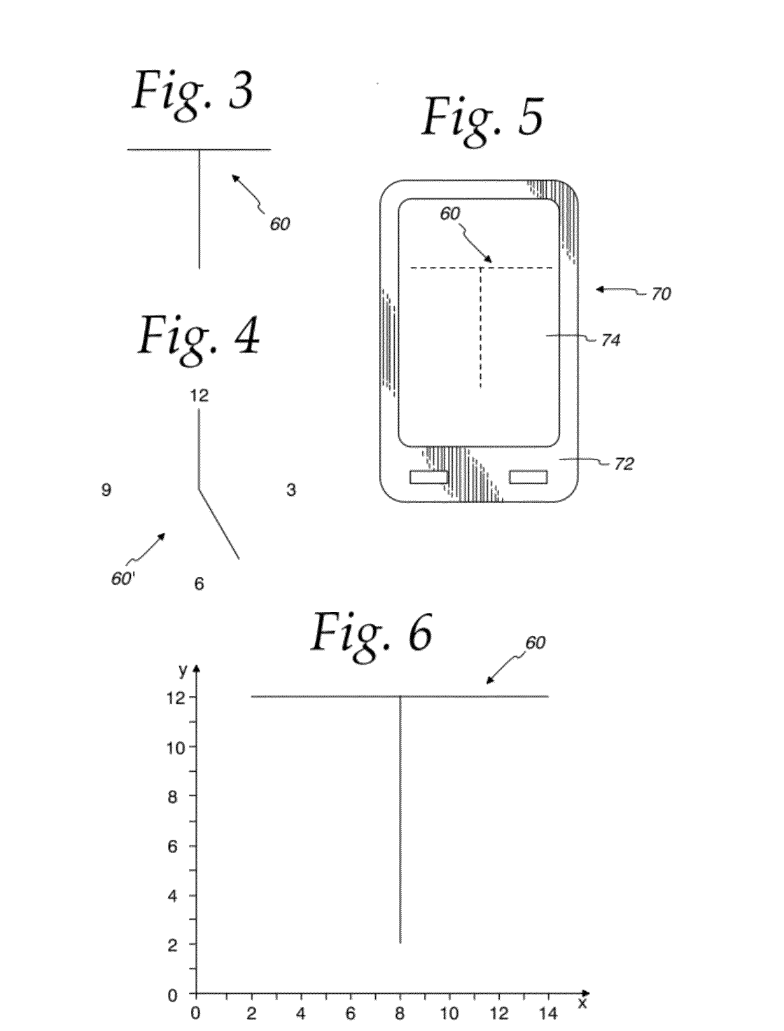

In an illustrative embodiment, sensory output system 10 is contained in a sensory output device 70, and the relevant information represented by the data input section signals is directed to the locations of points in a predetermined locus of points defining one or more predetermined shapes, for example, one or more points, lines or curves. FIG. 3 illustrates one particular locus of points defining a shape 60 in the form of the letter “T.” FIG. 4 illustrates another locus of points defining a shape 60′ in the form of hands and numbers emulating the face of an analog clock. FIGS. 3 and 4 illustrate only two of an infinite number of shapes that could by represented by electrical signals. Other such shapes could include upper and lower-case alpha characters, numeric characters, Braille characters, symbols, and icons, among other geometric forms.

The locus of points defining a one or two-dimensional shape can be represented mathematically in terms of the locations of the individual points comprising the shape in a Cartesian coordinate system or another two-dimensional coordinate system. For example, with reference to FIG. 6, the letter “T” could be represented as the locus of points extending from x,y coordinates (8,2) to (8,12) and from x,y coordinates (2,12) to (14,12). One skilled in the art would understand how to represent other shapes, for example, shape 60′ illustrated in FIG. 4, in a similar manner and also how to represent loci of points generally in other forms of coordinate systems. One skilled in the art further would recognize how to represent such information as an electrical signal or signals.

Data input section 20 could store or generate such signals and selectively provide them to processing section 40. Alternatively, such signals could be generated elsewhere and data input section 20 could act as a conduit for receiving such signals and providing them to processing section 40. If generated elsewhere, the signals could be provided to data input section 20 via wired or wireless means, as would be recognized by one skilled in the art. Similarly, data input section 20 could provide the signals to processing section 40 via wired or wireless means.

User input section 30 could be adapted to generate signals indicative of user input to a user input apparatus at locations corresponding to the locus of points discussed above in connection with data input section 20. For example, user input section 30 could be embodied as a capacitive or other form of touch pad or touch screen 74 and associated circuitry adapted to detect and discern the location, with respect to the area defined by the touch pad, of a stimulus, for example, a user's finger, in contact therewith or in proximity thereto. The construction and operation of such touch pads and touch screens is well-known to those skilled in the art and will be discussed herein only generally. In embodiments using touch screens, the touch screens need not be illuminated, be illuminable or display visual information.

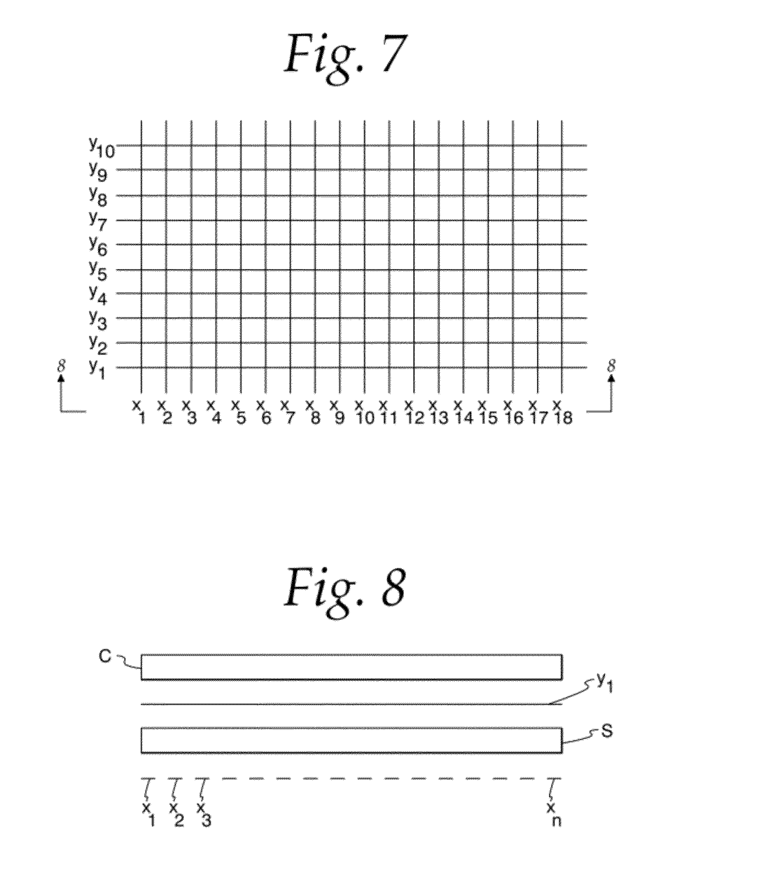

As shown in FIGS. 7 and 8, touch pads typically include a first set of parallel electrodes x₁-xₙ (sometimes referred to herein as “x-electrodes”) disposed on one side of a dielectric substrate S and a second set of parallel electrodes y₁-yₙ (sometimes referred to herein as “y-electrodes”) disposed on the other side of substrate S. The x-electrodes typically are oriented orthogonally to the y-electrodes, so that the x-electrodes “intersect” with the y-electrodes (the x-electrodes and y-electrodes do not touch because they are separated by substrate S). As discussed further below, a sensor is formed at each location where the x-electrodes intersect with the y-electrodes. Each such sensor is responsive to a stimulus, for example, a user's touch, to cover C proximate the sensor location. The foregoing electrode and substrate assembly is disposed underneath a dielectric cover C forming a generally two-dimensional surface that a user can run a finger over. Cover C typically is made of a substantially opaque plastic or rubber material, devoid of any markings, indicia or other perceptible information, particularly, perceptible information corresponding to or representative of the relevant information. As such, touch pads typically are not illuminated and typically do not display any visually or otherwise perceptible information. Touch screens typically are constructed in a similar manner, but further include backlighting and/or an LCD display on the side of the electrode assembly opposite the cover C. Also, in a touch screen, the electrodes, intervening substrate S and cover C typically are substantially transparent so that the backlighting and/or information set forth on the LCD is visible to a user. (Any or all of the electrodes, intervening substrate S and cover C of a touch pad could be transparent but typically would be opaque.)

The x-electrodes and y-electrodes are coupled to a control circuit (not shown) as would be known to those skilled in the art. The control circuit periodically applies a strobe signal to one of the x-electrodes (sometimes referred to herein as “drive electrodes”) while at the same time tying the rest of the x-electrodes to ground or another reference potential. The strobe signal generates an electric field about the x-electrode. This electric field couples to the y-electrodes (sometimes referred to herein as “sense electrodes”) about each sensor location, thereby establishing mutual capacitances between the x-electrode and the y-electrodes (“drive-sense mutual capacitance”) at each sensor location.

The foregoing drive-sense mutual capacitances will have a steady state value in the absence of a stimulus proximate the respective sensor locations. Introduction of a stimulus, for example, a finger or other conductive object, proximate a particular sensor location can result in a portion of the electric field about that sensor location coupling to the stimulus, thereby establishing a mutual capacitance between the drive electrode and the stimulus at that sensor location. This phenomenon lessens the drive-sense mutual capacitance at that sensor location.

The control circuit detects the drive-sense mutual capacitance at each of the sensor locations. The control circuit distinguishes between the steady state drive-sense mutual capacitance at each of the sensor locations and the lessened drive-sense mutual capacitance resulting from introduction of a stimulus (if any) proximate the sensor location. The control circuit provides an output indicative of the presence or absence of a stimulus proximate a sensor location based on the drive-sense mutual capacitance at that sensor location.

As such, user input section 30 is adapted to provide information regarding the location of a user's touch to a touch pad in terms of a Cartesian coordinate system in the form of one or more electrical signals. User input section 30 can provide these electrical signals to processing section 40. The coordinate system of the touch pad and user input section 30 can be made to correspond to the coordinate system of data input section 20 using scaling techniques and/or other techniques as would be known to one skilled in the art.

Touch pads and touch screens may be constructed in other ways and operate upon other principles, as well. One skilled in the art would understand how to adapt such alternative touch pads and touch screens for use with system 10.

Processing section 40 receives the signals provided from data input section 20 and user input section 30 and compares the signals to each other. When the two sets of signals correspond according to predetermined criteria, processing section 40 provides to output section 50 an output signal, as discussed above, indicating that the correspondence criteria have been satisfied. Processing section 40 otherwise provides an output signal, as discussed above, indicating that the correspondence criteria have not been satisfied.

Processing section 40 could be adapted to deem the correspondence criteria to be satisfied when a user touches touch pad 74 at any location that corresponds to the location of a point in the locus of points set forth in data input section 20. For example, with reference to FIG. 6, processing section 40 could be adapted to deem the correspondence criteria to be satisfied when a user touches touch pad 74 at any location that corresponds to the location of any point in the locus of points defining the letter “T.” As such, processing section 40 would provide an output signal indicating that the correspondence criteria have been satisfied whenever the user touches touch pad 74 at a location corresponding to x,y coordinates (8,2) to (8,12) and x,y coordinates (2,12) to (14,12). Conversely, processing section 40 would provide an output signal indicating that the correspondence criteria have not been satisfied whenever the user touches touch pad 74 at a location not corresponding to x,y coordinates (8,2) to (8,12) and x,y coordinates (2,12) to (14,12) or does not touch the touch pad at all.

Sensory output section 50 could receive the foregoing output signals from processing section 40 and selectively generate a sensory output signal in response to an output signal indicating that the correspondence criteria have been met. The sensory output signal could be used to generate a visual, audible, haptic or other sensory output. For example, the sensory output signal could be used to generate haptic output causing sensory output device 70 to vibrate in response to the user touching touch pad 74 at a location corresponding to any point in the locus of points 60 defining the letter “T” as shown in FIG. 5. In other examples wherein the relevant information defines another locus of points, the sensory output signal could cause sensory output device 70 to vibrate in response to the user touching touch pad 74 at any location corresponding to any point in locus of points defined by the relevant information. In some embodiments, the sensory output could additionally or alternatively be provided remote from sensory output device 70. For example, the sensory output could be provided in another, remote device in tethered or wireless communication with sensory output device 70.

The sensory output signal could be a discrete, instantaneous signal, an extended signal or a continuous signal. A single sensory output signal could be established in response to each occurrence of the correspondence criteria being satisfied or multiple sensory output signals could be established in response to each occurrence of the correspondence criteria being satisfied.

In an embodiment, the relevant information provided by data input section 20 to processing section 40 could represent one or more Braille characters. A user's touch to portions of touch pad 74 corresponding to any point in the locus of points defining the Braille character could cause device 70 or an associated device to vibrate. In this manner, sensory output device 70 could be used as a quasi-Braille reader enabling a user to “read” the Braille character(s) represented by the relevant information by interpreting the haptic feedback provided by device 70, rather than by visual observation or direct tactile feedback.

Sensory output system 10 could be configured to allow a user to manipulate touch pad 74 to read one Braille character at a time. A user, having read a particular character in the manner described above and ready to read another character could provide an input to system 10 directing data input section 20 to refresh, that is, to define a new set of relevant information, for example the next Braille character in a series of Braille characters. Auxiliary switches or sensors 76 could be provided for this purpose. Alternatively, the user could touch a predetermined portion of touch pad 74, perhaps a corner thereof, or swipe touch pad 74 from side-to-side or top-to-bottom to direct data input section 20 to refresh. Sensory output device 70 also could be adapted to allow a reader to read an entire line or page of Braille characters at a time. Upon reading the entire line or page, the user could direct data input section 20 to refresh as set forth above. The “refresh” concept also could be used in connection with embodiments other than the quasi-Braille reader embodiment.

As suggested above, sensory output device 70 could be embodied as a smart phone. A typical smart phone includes data input means including components adapted to receive, store and/or generate data, a processor, a touch screen, haptic output means including components adapted to provide haptic output, and associated circuitry. The data input means could include a wireless receiver, memory and/or other structure, as would be understood by one skilled in the art. The data input means could be adapted to represent data as a locus of points in a two-dimensional coordinate system. For example, the data could represent a Braille character or other geometric form. In an embodiment, the data could represent any time (provided by a clock in the smart phone or a remote source) in terms of a locus of points defining the face and hands of clock or alphanumeric characters representing the time. The data input means could, but need not, use the foregoing processor (or another processor) in doing so. The data input means can be adapted to provide corresponding signals to the foregoing processor.

The touch screen and associated circuitry can receive touch input from a user and provide signals indicative of the touch locations to the foregoing processor, as described above. The processor could be adapted to compare the signals indicative of the touch locations to signals received from the data input means representing the locus of points and to provide to the haptic output means a corresponding output signal when it deems the signals from the data input means and the touch pad to correspond, as described above. The haptic output means could include an LRA and/or other means for vibrating the smart phone, as discussed above. In operation, the smart phone would vibrate whenever the user touched a portion of the touch screen corresponding to the location of any point in the locus of points defined by the data input means. In the present example, wherein the locus of points defines a clock's face and hands, the smart phone would vibrate whenever the user touched a portion of the touch pad corresponding to a portion of the clock's face and hands. In this manner, the user could determine the time without looking at the touch screen. Indeed, in operation, the touch screen could be blanked and/or darkened or otherwise devoid of visible information.

Other portable devices could be readily adapted as a sensory output device 70. For example, portable music players, e-readers, and tablet computers typically include means for storing and/or receiving data that could be represented as a locus of points, a processor and a touch pad or touch screen. Such devices could be adapted to further include haptic output means as discussed above. Any of the foregoing devices including these or substantially similar elements could be adapted to function as a sensory output system 10. To the extent that such devices include screens that can output visual information, the ability to provide visual information generally is unnecessary to operation of sensory output system 10. Accordingly, the touch screens of such devices can remain blanked or darkened in connection with operation of sensory output system 10.

In other embodiments, sensory output system 10 could be contained in a single, non-portable device or distributed among numerous portable or non-portable housings, panels, containers and/or other devices. Also, the relevant information need not be representative of a geometric form or shape. Instead, the relevant information could be representative of some measurable quantity, for example, fluid level, position, temperature, voltage, speed, or orientation, among others. Further, the relevant information could be generated by or embodied as the digital or analog output of discrete digital or analog switches or sensors adapted to measure such quantities. Such switches could include, without limitation, membrane switches, push button switches, rotary switches, magnetic switches, bimetal switches and other types of electromechanical switches. Such sensors could include field effect sensors, for example, the so-called TS-100 or TS-100PE field effect sensors marketed by TouchSensor Technologies, LLC of Wheaton, Ill. The general principle of operation of the TS-100 sensor is described in U.S. Pat. No. 6,320,282, the disclosure of which is incorporated herein by reference in its entirety. Such sensors also could include, without limitation, capacitive sensors, magnetic sensors, optical sensors, inductive sensors, trapped acoustic resonance sensors, temperature sensors, voltmeters, ammeters, ohmmeters, flow meters, and float switches. Similar switches and sensors also could be used to detect and provide output indicative of user input to user input section 30, as would be understood by one skilled in the art.

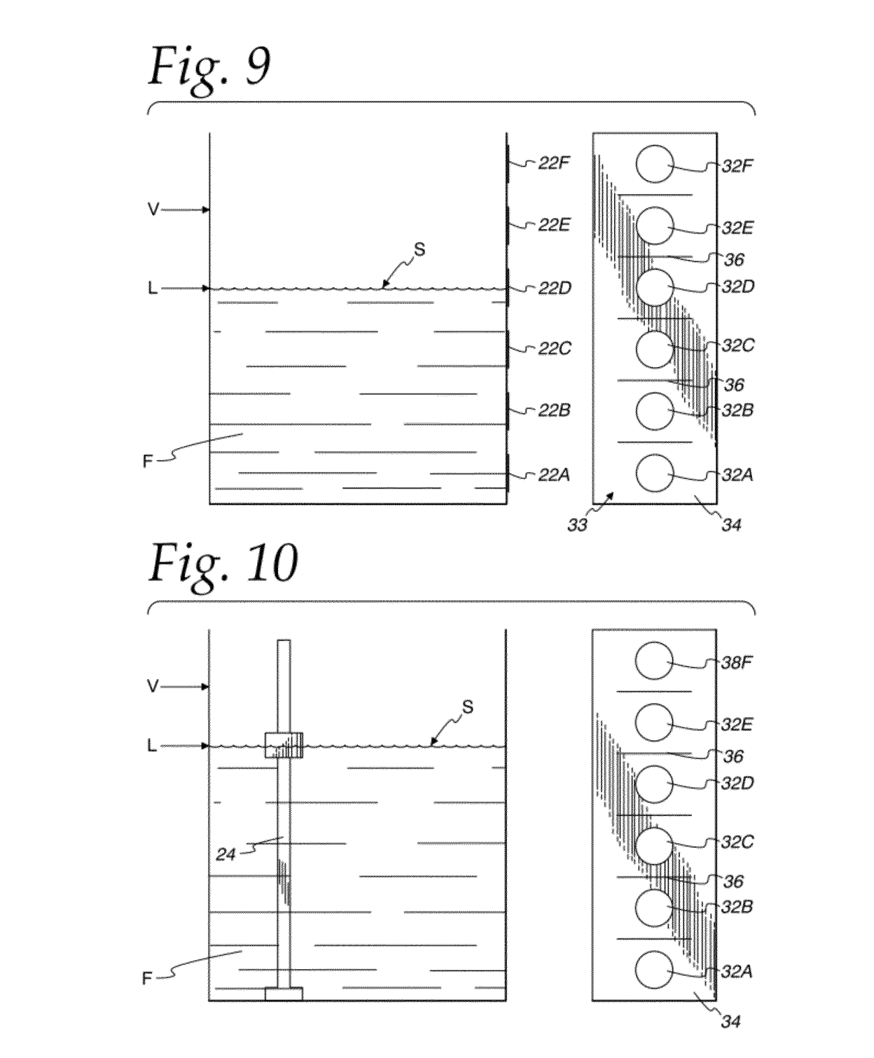

In an illustrative embodiment, sensory output system 10 could be adapted to provide sensory output indicative of the level of a fluid F in a vessel V. FIG. 9 illustrates a vessel V containing a fluid F having a free surface S at level L. Six data input section sensors 22A-22F are disposed on or embedded within the side wall of vessel V. Each of data input section sensors 22A-22F could be adapted to detect the presence of fluid F in proximity thereto and to provide an output indicative of the presence or absence of fluid F in proximity thereto. The output could be in the form of a first signal, for example, a high level signal, when fluid F is in proximity to the sensor, and in the form of a second signal, for example, a low level signal, or a null signal when the fluid is not in proximity thereto. Alternatively, the output could be in the form of a low level signal or null signal when fluid F is in proximity to the sensor and in the form of a high level signal when the fluid is not in proximity thereto. More or fewer than six data input section sensors 22 (as few as one) could be used in other embodiments.

FIG. 9 illustrates the free surface S of fluid F at a level L corresponding to the level of input section sensor 22D and, therefore, at or above the levels of each of input section sensors 22A-22D and below the levels of each of input section sensors 22E-22F. In this state, each of input section sensors 22A-22D would output a first signal indicative of the proximity of fluid F thereto, and each of input section sensors 22E-22F would output a second signal indicative of the absence of fluid F in proximity thereto.

FIG. 9 also illustrates a user input module 34 including six user input section sensors 32A-32F arranged on panel surface 33 in a manner that mimics the placement of input section sensors 22A-22F on vessel V. As such, user input module 34 emulates a level gauge corresponding to the height of vessel V. User input module 34 could, but need not, be configured so that user input section sensors 32A-32F are oriented vertically, further emulating such a level gauge.

FIG. 9 further illustrates optional tactile structure in the form of frets 36 on panel surface 33 between adjacent pairs of user input section sensors 32i. Although optional, frets 36 can be desirable, particularly in embodiments where panel surface 33 is a smooth surface of a user interface panel or other substrate and user input section sensors 32i are realized as discrete electronic sensors located underneath the panel surface. Frets 36 could be embodied in the form of tape strips, arrangements of bumps, or other raised (relative to the surface on which user input section sensors 32i are located) structure between adjacent pairs of user input section sensors 32i. Alternatively, frets 36 could be embodied as depressions formed into the surface on which user input section sensors 32i are located. Where provided, frets 36 could provide non-visual indication (which non-visual indication could visual elements, as well) of the relative position of a user's finger or other object with respect to the array of user input section sensors 32i and/or movement from the region about one of user input section sensors 32i to the region about another of user input section sensors 32i. Other tactile indicia could be provided in addition to or instead of frets 36 to further provide such non-visual indication.

Each of user input section sensors 32A-32F could be adapted to detect input by a user and to provide an output indicative of such input, as would be understood by one skilled in the art. The output could be in the form of a first signal, for example, a high level signal, when user input is detected, and in the form of a second signal, for example, a low level signal, or a null signal when user input is not detected. Alternatively, the output could be in the form of a low level signal or null signal when user input is detected and in the form of a high level signal when user input is detected is not detected. More or fewer than six user input section sensors 32i (as few as one) could be used in other embodiments. The number and locations of user input section sensors 32i typically would, but need not, correspond to the number and locations of input section sensors 22i on vessel V.

The output signals of data input section sensors 22A-22F and user input section sensors 32A-32F are provided to processing section 40. Processing section 40 could be located in user input device 34 or remotely, for example, in another device elsewhere. In either case, processing section 40 could be in wired or wireless communication with data input section sensors 22A-22F and user input section sensors 32A-32F. Processing section 40 receives these signals and compares them to each other. When the two sets of signals correspond according to predetermined criteria, processing section 40 provides to output section 50 an output signal indicating that the correspondence criteria have been satisfied. Processing section 40 otherwise provides an output indicating that the correspondence criteria have not been satisfied.

The correspondence criteria could be established as desired for any particular application. For example, the correspondence criteria could be established so that they would be satisfied when the user input section sensor 32A-32F corresponding to the uppermost of data input section sensors 22A-22F detecting the proximity of fluid F in vessel V is actuated but not when any other user input section sensor is actuated. With reference to FIG. 9, wherein the uppermost data input section sensor detecting the proximity of fluid F is input section sensor 22D, such correspondence criteria would be satisfied when user input section sensor 32D is actuated but not when any of output section sensors 38A-38C and 38E-38F is actuated.

Alternatively, the correspondence criteria could be established so that they would be satisfied when any user input section sensor 32A-32F corresponding to any input section sensor 22A-22F detecting the proximity of fluid F in vessel V is actuated but not when any other input section sensor is actuated. With reference again to FIG. 9, such correspondence criteria would be satisfied when any of user input section sensors 38A-38D is actuated, but not when any of input section sensors 32E-32F is actuated.

The output from processing section 40 is provided to sensory output section 50. Sensory output section 50 could selectively provide a sensory output signal causing actuation of a sensory output element in response to an appropriate signal from processing section 40 at a desired location and in a desired manner. The sensory output element could provide visual, audible or haptic output. For example, the sensory output element could be an LED, buzzer, or LRA incorporated into user input device 34. These sensory output elements could be illuminated, sounded or caused to vibrate (thereby vibrating user input device 34), respectively, in response to a sensor output signal. In other embodiments, the sensory output element could be located remotely, for example, at a panel or device separate from user input device 34.

The sensory output, whether visual, audible or haptic, could be in the form of a discrete sensory pulse or an extended sensory output in response to each instance of the correspondence criteria having been satisfied. For example, with reference to the example set forth in Paragraph [0049] above, a discrete pulse of sensory output could be provided in response to simultaneous actuation of both data input section sensor 22D and user input section sensor 32D. A further pulse would not be generated until data input section sensor 22D and user input section sensor 32D were no longer simultaneously actuated and were then again simultaneously actuated. Alternatively, the sensory output could be of extended duration for each instance of the correspondence criteria having been satisfied. In other embodiments, the sensory output could be continuous from the time the correspondence criteria are first satisfied until the correspondence criteria are no longer satisfied.

The form of output could be established in processing section 40 and/or sensory output section 50. For example, processing section 40 could provide a single pulsed, extended or continuous output signal in response to each instance of the correspondence criteria having been satisfied. Also, as illustrated in FIG. 2A, sensory output section 50 could include a haptic output signal generation unit adapted to provide a single haptic waveform of predetermined length in response to such output signals from processing section 40. This waveform could be provided to an LRA driver. The LRA driver, in turn, could use this waveform to actuate an LRA or other suitable haptic output element for a length of time corresponding to the length of the haptic effect waveform.

In some embodiments, two or more haptic waveforms could be provided serially in response to each output signal from processing section 40 indicating that the correspondence criteria have been met, extending the overall duration of actuation of the LRA for each occurrence of the specified criteria being met.

In other embodiments, an unlimited number of haptic waveforms could be provided serially in response to each output signal from processing section 40 indicating that the correspondence criteria have been met, effectively resulting in continuously generate haptic effect waveforms, effectively causing continuous actuation of the LRA for the entire duration that the correspondence criteria are met.

Alternatively, a continuous haptic output signal could be provided for a predetermined duration for each occurrence of the correspondence criteria being met. For example, the haptic output signal could be continuous for several seconds (or a greater or shorter length of time) for each occurrence of the correspondence criteria being met.

In other embodiments, a continuous haptic output signal could be provided for the entire duration that the correspondence criteria are met, effectively causing continuous actuation of haptic output device 42 for the entire duration that the correspondence criteria are met.

Although the FIG. 9 embodiment involves level sensing, one skilled in the art would recognize that the principles discussed in connection therewith readily could be adapted to applications involving other parameters of interest, for example, position sensing. One such application could involve an automobile seat mounted on a track allowing fore and aft adjustment as would be understood be one skilled in the art. The track could include a fixed member attached to the vehicle and a movable member attached to the seat, as would be recognized by one skilled in the art. The fixed member could be provided with data input section sensors 22i in the form of discrete position sensors, and the movable member could include triggering structure to actuate any or all of the input section sensors when in proximity thereto. The data input section sensors could thereby provide signals to processing section 40 indicative of the position of the movable member relative to the fixed member, thus providing an indication of the position of the seat relative to the range of fore and aft travel available to it.

User input section sensors 32i could be provided, for example, on a panel located on the side of the seat, preferably in a linear array mimicking the bounds of travel of the seat on the track. A user could run a finger along the panel to actuate individual ones of the output position sensors 32i, the outputs of which also would be provided to processing section 40. A sensory output element could be actuated when the user actuates the user input section sensor 32i corresponding to the relative position of the seat. Alternatively, the sensory output element could be actuated when the user actuates the user input section sensor 32i corresponding to the relative position of the seat or any user input section sensor 32i corresponding to a seat position fore or aft of that position.

FIG. 10 illustrates an application similar to that illustrated in FIG. 9, but wherein the data input section sensor is embodied as a float-type sensor 24 located in vessel V instead of discrete sensors 22A-22F associated with a side wall of vessel V. Float sensor 24 preferably is adapted to provide a proportionally variable (for example, analog) output indicative of the level of the fluid in vessel V. The output of float sensor 24 can be processed to yield a signal indicative of the level L of the free surface of fluid F in vessel V, as would be understood by one skilled in the art. This processing could be performed by a processor located in input section 20 or elsewhere. For example, this processing could be performed in processing section 40.

The correspondence criteria used by processing section 40 could be established so that they would be satisfied only when the output section sensor 32A-32F corresponding most closely to the level L of the free surface of fluid F in vessel V is actuated. Alternatively, the correspondence criteria used by processing section 40 could be established so that they would be satisfied when any output section sensor 32A-32F corresponding to the level L of the free surface of fluid F or a level below level L is actuated. The correspondence criteria could be establishes in other ways, as well.

Although this example is directed to an application involving level sensing, one skilled in the art would recognize that its principles readily could be adapted to applications involving other parameters of interest, for example, voltage, current, speed, position, among others, by replacing float switch 50 with an appropriate sensor associated with the parameter of interest. One such application could involve provision of sensory output as an indication of remaining energy in a power source, for example, a battery for a laptop computer. Means, as would be recognized by one skilled in the art, for sensing the remaining energy could provide to processing section 40 one or more signals indicative of the remaining energy. Such means could include, without limitation, a voltmeter for determining battery voltage, an ammeter for determining current delivered by the battery to a load, and/or a means for determining the battery's internal resistance.

User input section sensors 32i could be provided, for example, on a panel located on a surface of the computer. Such user input section sensors 32i preferably would be arranged in an array, linear or otherwise, mimicking a charge meter. A user could run a finger along the panel to actuate individual ones of user input section sensors 32i, the outputs of which also would be provided to processing section 40. A sensory output element could be actuated when the user actuates the user input section sensor 32i most closely corresponding to the level of remaining energy in the battery or other power source. Alternatively, the sensory output element could be actuated when the user actuates the user input section sensor 32i corresponding to the level of remaining energy or any user input section sensor 32i corresponding to the level of remaining energy or any greater or lower level of remaining energy.

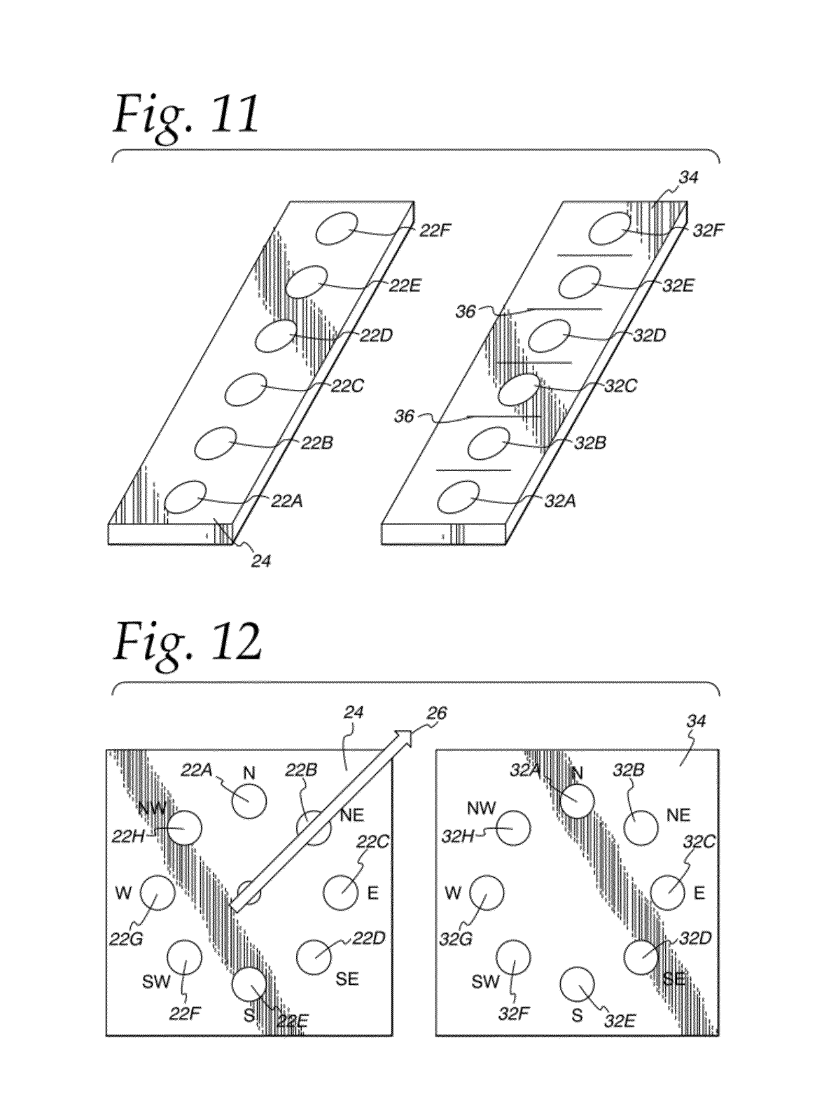

FIG. 11 illustrates an application wherein data input section sensors 22A-22F are disposed in a data input module 24 in a manner emulating a slide switch. FIG. 11 also illustrates user input module 34, which is similar to user input module 34 described above in connection with FIGS. 9 and 10. Data input module 24 could be used, for example, to set an output level for a controlled device, for example, a lighting unit, an audio apparatus, a motor, etc., by a user touching or otherwise actuating one of data input section sensors 22A-22F corresponding to the desired level. Signals representative of the selected output level could be provided to and/or stored in processing section 40. A user could remotely monitor and be provided with sensory output regarding the selected level by selectively actuating individual ones of user input section sensors 32A-32F. Signals representative of the actuation status of sensors 32A-32F could be provided to processing section 40. Processing section 40 could compare the signal(s) provided by the user input section sensor(s) 32A-32F actuated by the user to the foregoing data input section signal(s) and cause a sensory output to be generated using the principles discussed above.

FIG. 12 illustrates a data input module 24 in the form of a weathervane in which data input section sensors 22A-22H are disposed on a panel of data input module 24 in locations corresponding to the compass points N, NE, E, SE, S, SW, W and NW, respectively. A movable pointer 26 is provided in association with input section sensors 22A-22H. Pointer 26 could comprise a conductive mass or include a conductive mass disposed thereon or therein such that the conductive mass travels into and out of proximity with, and thereby selectively actuates, individual ones of input section sensors 22A-22H as pointer 60 rotates. Signals representative of the input section sensor 22A-22H as a function of time could be provided to processing section 40.

FIG. 12 also illustrates user input module 34 having user input section sensors 32A-32H corresponding to the compass points N, NE, E, SE, S, SW, W and NW, respectively. A user could remotely monitor and be provided with sensory output regarding the position of pointer 26 by selectively actuating individual ones of user input section sensors 32A-32H. Signals representative of the actuation status of user input section sensors 32A-32H could be provided to processing section 40. Processing section 40 could compare the signal(s) provided by the user input section sensor(s) 32A-32H to the foregoing data input section signal(s) and cause a sensory output to be generated using the principles discussed above. The principles discussed in connection with FIG. 12 could be applied to emulate and monitor the status of a rotary switch, as would be recognized by one skilled in the art.

In other applications, user input section sensors 32i could be arranged in other ways. For example, user input section sensors 32i could be arranged in semi-circular, rectangular, ovoid, curvilinear, or irregularly-shaped arrays. A three-dimensional array could be realized by locating user input sections sensors 32i on a non-planar surface or multiple surfaces of a panel or other substrate.

The number, type, and arrangement of data input section sensors 22i and user input section sensors 32i discussed and shown in the foregoing examples and illustrations, as well as the examples and illustrations themselves are merely exemplary and are not intended to limit the scope of the invention as claimed below. Indeed, the number, type, and arrangement of data input section sensors 22i and user input section sensors 32i used in a particular embodiment would depend on the application, as would be recognized by one skilled in the art.

In the FIGS. 9-12 embodiments, user input section sensors 32i are illustrated and described as discrete sensors. In other embodiments, user input section sensors 32i could be embodied as switches or in other suitable forms. For example, some or all of user input section sensors 32i could be embodied as one or more touch pad, touch screens or similar devices.

As described above, and as would further be recognized by one skilled in the art, other forms of sensory output devices and appropriate means for actuating them could take the place of the haptic output devices and means for actuating them set forth in the foregoing description and examples. Also, the principles described in connection with a particular example, application, or embodiment herein could be applied to other examples, applications, or embodiments described herein, as would be recognized by one skilled in the art. Further, one skilled in the art would understand that the embodiments disclosed herein could be modified in other ways without departing from the scope of the following claims.

1. A sensory output system comprising:
a data input section adapted to provide one or more electrical signals representative of relevant information;
a user input section comprising a plurality of sensing elements, each of said sensing elements adapted to provide an electrical signal representative of user input thereto;
a processor adapted to
receive said electrical signals from said data input section and said electrical signals from said user input section,
compare said electrical signals received from said data input section with said electrical signals received from said user input section, and
provide a sensory output signal when any of said electrical signals received from said user input section corresponds to a respective one of said electrical signals received from said data input section according to predetermined criteria; and
a sensory output section adapted to receive said sensory output signal from said processor and to provide a sensory output in response to said sensory output signal.

2. The system of claim 1 wherein said sensory output comprises haptic output.

3. The system of claim 1 wherein said relevant information is representative of a geometric form.

4. The system of claim 3 wherein said geometric form emulates an alphanumeric character.

5. The system of claim 3 wherein said geometric form emulates a clock face.

6. The system of claim 3 wherein said geometric form emulates a Braille character.

7. The system of claim 3 wherein ones of said plurality of sensing elements are arranged in a form corresponding to said geometric form.

8. The system of claim 7 wherein said plurality of sensing elements comprises a touch input pad.

9. The system of claim 8 wherein said touch input panel is substantially devoid of perceptible information representative of said geometric form.

10. The system of claim 8 wherein said geometric form is not displayed on said touch input panel.

11. A method of enabling a user to determine the content of relevant information using a sensory output device, comprising the steps of:
providing a plurality of electrical signals collectively representative of said relevant information;
providing a user input section, said user input section comprising a plurality of sensing elements, each of said sensing elements adapted to provide an electrical signal representative of user input thereto;
providing a processor adapted to receive said electrical signals from said data input section and said user input section, said processor adapted to compare said electrical signals received from said data input section with said electrical signals received from said user input section and further adapted to provide a sensory output signal when any of said electrical signals received from said user input section corresponds to a respective one of electrical signals received from said data input section according to predetermined criteria; and
providing a sensory output section adapted to receive said sensory output signal from said processor and to provide a sensory output in response to said sensory output signal.

12. The method of claim 11 wherein said sensory output comprises haptic output.

13. The method of claim 11 wherein said relevant information is representative of a geometric form.

14. The method of claim 13 wherein said geometric form emulates an alphanumeric character.

15. The method of claim 13 wherein said geometric form emulates a clock face.

16. The method of claim 13 wherein said geometric form emulates a Braille character.

17. The method of claim 13 wherein ones of said plurality of sensing elements are arranged in a form corresponding to said geometric form.

18. The method of claim 17 wherein said plurality of sensing elements comprises a touch input panel.

19. The method of claim 18 wherein said touch input panel is substantially devoid of perceptible information representative of said geometric form.

20. The method of claim 18 wherein said geometric form is not displayed on said touch input panel.
